(19) United States
(12) Patent Application Publication
(10) Pub. No.: US 2013/0066609 A1
(43) Pub. Date: Mar. 14, 2013

(54) SYSTEM AND METHOD FOR DYNAMIC SIMULATION OF EMERGENCY RESPONSE PLANS

(71) Applicant: Bruce GILKES, Calgary (CA)

(72) Inventor: Bruce GILKES, Calgary (CA)

(73) Assignee: C4I CONSULTANTS INC., Calgary (CA)

(21) Appl. No.: 13/232,757

(22) Filed: Sep. 14, 2011

(51) Int. Cl. G06G 7/48

(52) U.S. Cl. 703/6

(57) ABSTRACT

A method to electronically create, store, validate, exercise with and view dynamic Emergency Response Plans (ERP) is provided. The system employs a local computer-based constructive simulation application (100, 200) or a server-based constructive simulation tool (300) that stores all information related to and ERP in a database (600) in a manner such that it can be visually edited (400), dynamically shown on screen (500), stored and transmitted to other users in a self-contained file format (600), and can be used in a networked exercise (550) where players can take control of assigned entities within the simulation of the ERP.

### FIELD OF THE INVENTION

Embodiments herein relate to a system and a methodology to electronically create, store, validate, exercise with and view dynamic Emergency Response Plans (ERP). More particularly, either local or networked computers create and store ERP data that can be shared, via self-contained data format, with other users in a networked exercise for dynamic control of entities, presentation and interaction. Another embodiment relates to how ERP plans are prepared, managed and shared, and used in the training process.

### BACKGROUND OF INVENTION

Emergency Response Planning (ERP) processes are used at the municipal, state, and federal levels, as well as within certain industries. ERPs describe how an agency or organization will react in response to one or more unusual events. It is a playbook of policies and procedures that are agreed upon beforehand, coordinated with other agencies and practiced when possible.

Conventional ERPs suffer from several deficiencies. ERP plans are quite comprehensive and as a result it is difficult to understand. Lack of understanding leads to difficulties in implementing the plan. An ERP is currently contained in a large binder format that is difficult to peruse and understand. Similarly, it is difficult to practice an ERP realistically because, even live exercises where everyone plays their part, have limitations with respect to realism. Agencies are not allowed to endanger people for the purposes of an exercise. An alternative, being table top exercises, cannot adequately portray the depth, myriad of decisions and the unknowns that occur during an actual incident.

What is required is an electronic ERP which allows participants to create a foundation for ERP data, to visually observe the development of a scenario and dynamically interact with others in a simulation.

### SUMMARY OF INVENTION

Herein an electronic ERP is provided which allows participants to visually observe and easily understand the plan using a visual map display and further allows agencies to validate the plan and to train realistically using a constructive simulation. A standardized file format allows for seamless interchange of information between users, and between agencies and regulatory bodies.

Simulations can be run to train using the same communication tools as in real emergency response operations. Participants or players in an ERP simulation can dynamically make decisions, add entities and test feedback in simulation real time. Implementation of full featured GIS components provides a simulation interface including presentation of asset locations in time and space.

In an aspect, a system and method is provided for creating (400), validating (450), viewing (500), conducting training exercises (550) and reviewing the training and validating results of electronic ERPs using a server over the Internet (650). The system employs at least one client station that creates electronic ERP content that is stored on the server and can later be retrieved and used by other client stations.

In another aspect, a system and method is provided for creating, validating, viewing, conducting training exercises and reviewing the training and validation results using a single workstation. The system employs a workstation that creates ERP content that is stored locally and can later be retrieved and used by one or more other workstations.

In another aspect, a system and method is provided for creating, validating viewing, conducting training exercises and reviewing the training and validation results using multiple local workstations. The system employs a workstation that creates ERP content that is stored locally and later used by multiple workstations.

In another aspect, a file structure is provided for the compact storage of all relevant ERP scenario and data within a single digital file implemented widely such as that in a system of networked computers by one or more players or agencies. The file structure comprises static and active entity databases, mapping and GIS data that is stored locally and otherwise not retrievable from the Internet, all information related to the scenario and the positioning and movement of entities within the scenario and all information related to any natural or man-made phenomena that may impact the ERP.

In another aspect, a file structure is provided for the compact storage of all relevant After Action Review (AAR) data within a single digital file. The AAR file structure includes all static and active entity databases, all mapping and GIS data that is stored locally and not retrieved from the Internet, all information related to the scenario and the positioning and movement of entities within the scenario and all information related to any natural or man-made phenomena that may impact the ERP, as well as a record of all actions, reactions and events that occurred during the validation or exercise involving the ERP.

In another aspect, a process is provided whereby a user can create a digital ERP using a constructive simulation editor. The user can, at any time, add units, which can be agencies, organizations or even military units. The user can also add vehicles, personnel and equipment (entities) at any time, and relate these to a particular unit. The user can place entities on the map, as well as define on the map, critical infrastructure, terrain, facilities, and other features related to ERPs. At any time, the user can define an event such as a disaster or any other situation to which the entities would be exposed and save the information in a particular digital file structure (see para above). The constructive simulation engine allows the user to script the disaster and the response in a visual manner that allows them to understand the time and space relationship between different events, actions and reactions. The flexibility of the constructive simulation engine allows the user to incrementally devise their emergency response plan and iteratively test the plan to perfect it. The user can then modify the conditions of the disaster and further adjust the plan so it is able to withstand multiple disaster possibilities. This type of faster-than-real-time feedback and iterative planning can be very useful in speeding the design of ERPs that are flexible and realistic.

In another aspect, a process is provided whereby a user can validate a digital ERP using a constructive simulation tool. The user can open the ERP that is saved in a particular file structure and run the disaster within the constructive simulation. The constructive simulation applies scripts for movement and other activities and provides logic for the reaction or response of entities when these are exposed to certain situations, thresholds or conditions. The user observes the outcome of the simulation through viewing and interacting with the simulation and observing reports generated by the simulation. The user can verify that all aspects of the ERP are performing according to specifications by visually consulting the on-screen display of the constructive simulation playback and by referring to system-generated reports. The user is able to adjust any elements of the ERP to perfect the response, as well as adjust the elements of the disaster to ensure the ERP is flexible enough to respond to multiple contingencies. When the ERP is successfully validated against the desired contingencies, the user can save the ERP as an After Action Review (AAR) file, which can be transmitted to other users to observe, or they can save the ERP as a digital simulation file which can be transmitted to other users for further editing and review. The user can electronically enter or import expected outputs such as evacuation time and then the software will validate the final results of the simulation against the expected outcomes to determine the accuracy and realism of the plan. The software also generates a list of suggested changes such as evacuation routes or personnel and equipment deployments to improve the outputs of plan. The user can also use the software to simultaneously run multiple scenarios at once with different input parameters to allow the user to model unpredictable behaviours such as weather and human crowd reaction, population density based on the time of day and generate a statistical list of variant outcomes including minimum and maximum response times and the expected average response time.

In another aspect, a process is provided whereby a user can dynamically view or review the results of a digital ERP exercise or digital ERP validation. The user can open the ERP AAR that is saved in a particular file structure. The constructive simulation then replays the ERP as it occurred during the exercise or validation. The user can cause the simulation to play back the results in real time or faster than real time. The user observes the outcome of the simulation through viewing and interacting with the simulation and observing reports generated by the simulation. The AAR file is a replay of the constructive simulation and is itself not editable, however the user can annotate and provide comments (verbal, written, graphical) that can be integrated with the AAR file and played back during further reviews. The ERP AAR data also includes annotated screenshots generated during the exercise, any VOIP or message training data and a complete historical record of a simulated entity attribute data such as location, movement, supplies and health.

In another aspect, a process is provided whereby a user can use a digital ERP to conduct a training exercise. The user opens the constructive simulation and then opens the digital ERP that is stored in a particular digital file format. The user creates stations that will be played by exercise participants and assigns entities from the ERP to the stations according to the exercise design. The constructive simulation is started and the player stations join the simulation and begin controlling the entities in response to events that occur within the simulation. The process also includes using a Voice Over IP (VOIP) simulated radio/telephone system to pass voice communications between participants as well as a Master Scenario Events List (MSEL) tool that provides information-based messages to participants in response to events that occur within the simulation. The information-based messages can be triggered via simulation time, an emergency event occurrence, an attribute of an emergency event reaching a particular threshold, a relationship between a simulated entity and another simulated entity, a relationship between a simulated entity and a geographic location or an attribute of a simulation entity reaching a particular threshold. The MSEL can be used to inject simulated voice messages to simulate actual events and training points or triggers. The MSEL can also integrate with an email server or robo-dialer to further simulate an actual training scenario via integration with a company or trainee's industry standard telephony and email systems. All actions, reactions and events within the simulation, including VOIP and MSEL traffic, are logged and an AAR file with a particular file format is created allowing the instructor to digitally re-create and re-play the exercise to enhance training and highlight deficiencies in the operators current workflow or process. The embodiment herein of integrating all AAR data into one package allows the trainer to easily store the data for historical purposes such as validation evidence or easy distribution or sharing. The same digital ERP file that was used for creating, testing and validating the ERP is used with minimal modification for running the ERP exercise. The constructive simulation operates with one or more simulation “player” stations running initially and is able to add or remove other “player” simulation stations without stopping or restarting the simulation. The controller station is able to add or change VOIP radio stations without stopping or restarting the simulation, and the voice information received from these stations is fully integrated with the simulation AAR to be played back at the same simulation time that they were received. The controller station is able to add or change any MSEL traffic that has not been sent and is able to record all responses to the MSEL traffic and integrate these responses as well as the original message traffic into the AAR. The user is able to observe using a timeline control when the original message or messages were sent and when the responses were received, in relation to other events occurring during the simulation.

### BRIEF DESCRIPTION OF THE DRAWINGS

FIG. 1 is a schematic representation of an embodiment of a system for managing Emergency Response Plans (ERP);

FIG. 2 is a schematic representation of another embodiment of a system for managing Emergency Response Plans (ERP);

FIG. 3 is a schematic representation of a further embodiment of a system for managing Emergency Response Plans (ERP);

FIG. 4A is a flowchart illustrating the steps involved in creating the ERP of FIGS. 1, 2 and 3;

FIG. 4B is a flowchart illustrating the steps involved in validating the ERP of FIG. 4A;

FIG. 5A is a flowchart illustrating the steps involved in viewing the ERP of FIG. 4A;

FIG. 5B is a flowchart illustrating the steps involved in exercising with the ERP of FIG. 4A;

FIG. 6A is a schematic representation illustrating storing of the ERP of FIG. 4A in a file structure;

FIG. 6B is a schematic representation illustrating storing of After Activity Reviews (AAR) of the ERP of FIG. 4A in a file structure;

FIG. 7 is a schematic representation an ERP workflow program; and

FIGS. 8A to 11B are schematic representations of an embodiment of the processes involved in installing and setting up an ERP on a workstation, more particularly,

FIGS. 8A to 9A are screen captures of the steps involved in loading the ERP,

FIG. 9B is a screen capture illustrating creation of a new unit,

FIG. 9C is a screen capture illustrating addition of an entity to the unit of FIG. 9B,

FIG. 9D is a screen capture illustrating addition of attributes to the entity FIG. 9C,

FIGS. 10A to 10C are screen captures illustrating use of the entities of FIG. 9C and setting routes for such entities, and

FIGS. 11A and 11B are screen captures illustrating an embodiment of an ERP plan displayed on a screen as a dynamic themed map.

### DESCRIPTION OF THE PREFERRED EMBODIMENT

A system is provided for managing Emergency Response Plans (ERP) and use thereof. As shown, the system employs a local computer-based constructive simulation application (100, 200) or a server-based constructive simulation tool (300) that stores all information related to an ERP in a database (600) in a manner such that it can be visually edited (400), dynamically shown on screen (500), stored and transmitted to other users in a self-contained file format (600), and can be used in a networked exercise (550) where players can take control of assigned entities within the simulation of the ERP.

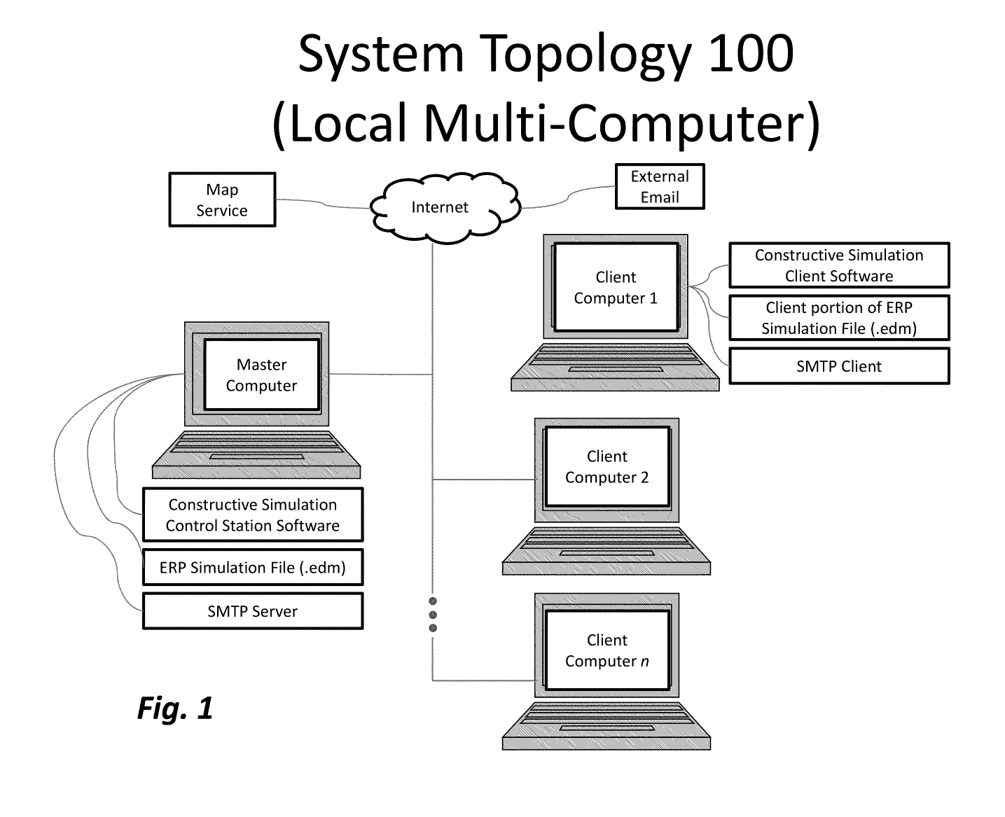

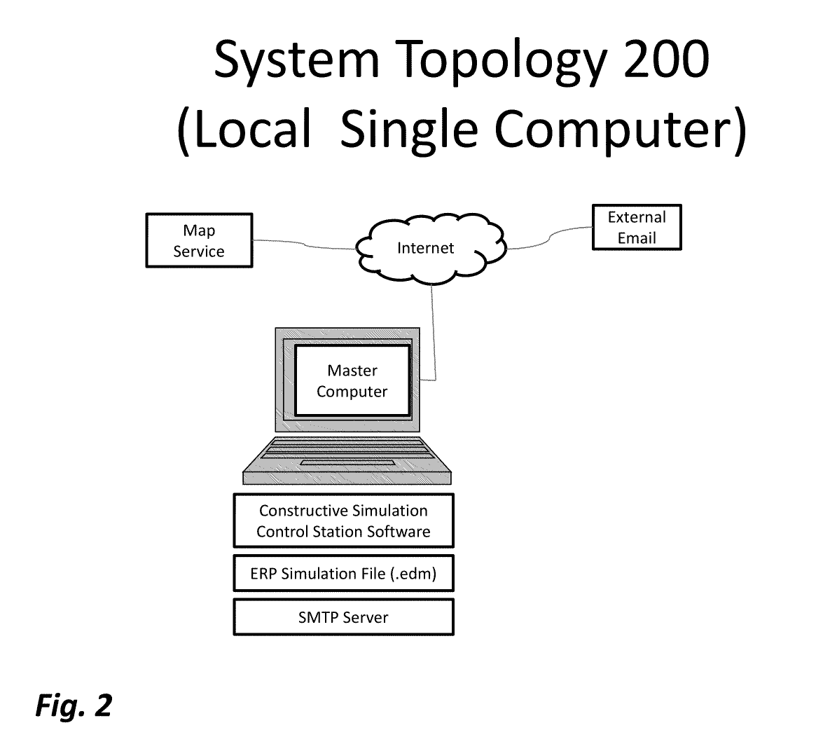

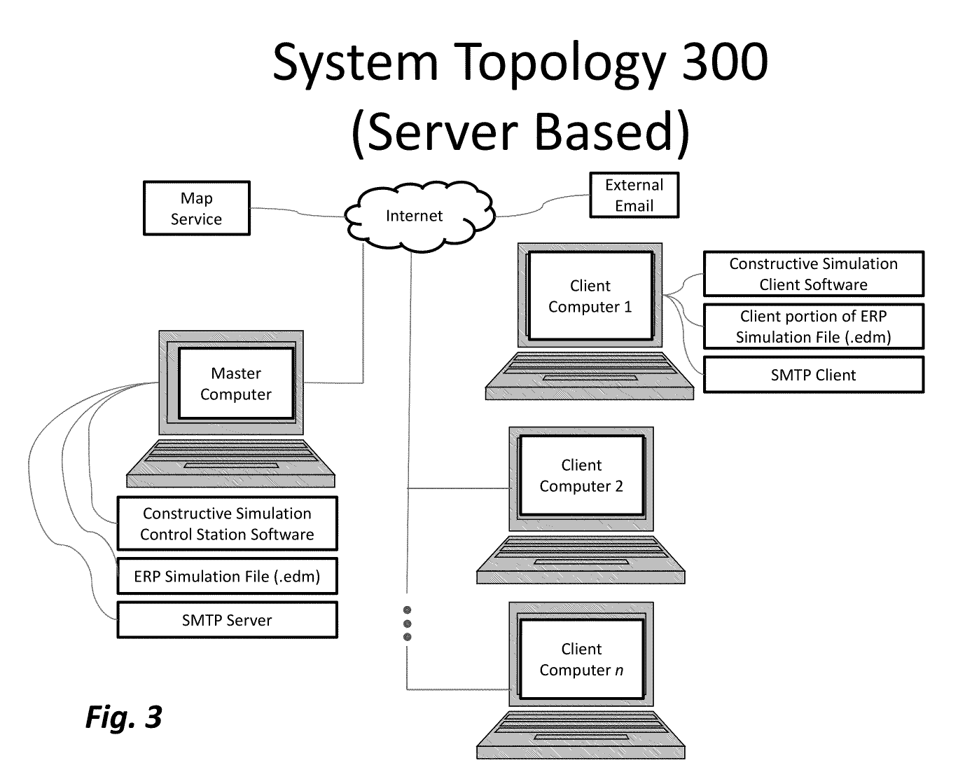

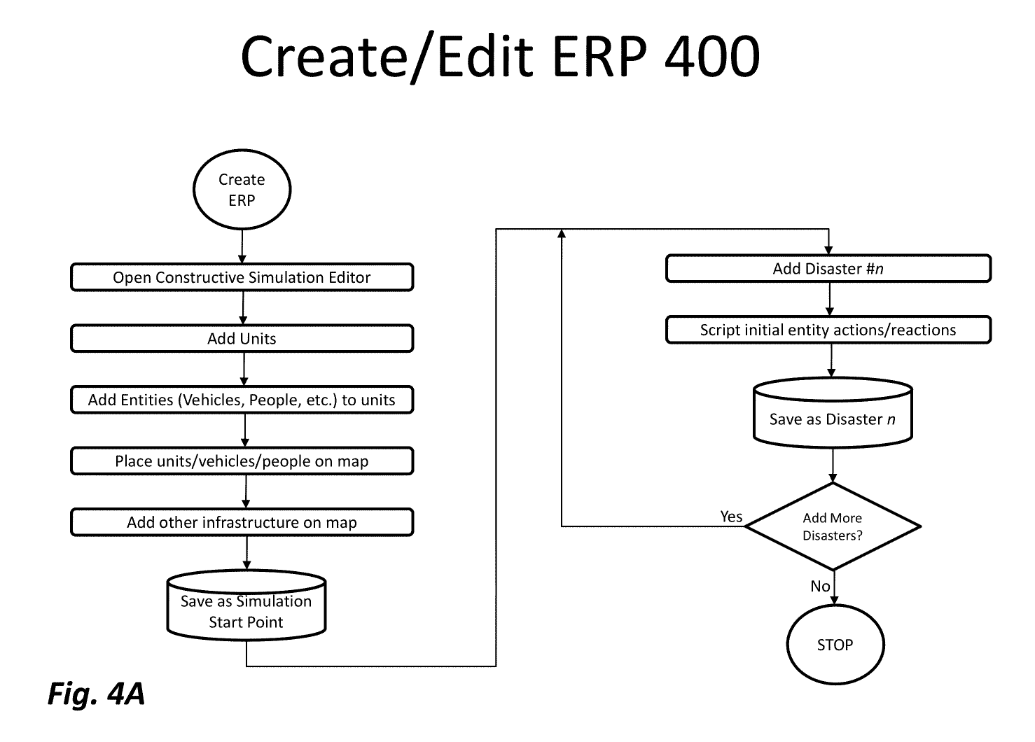

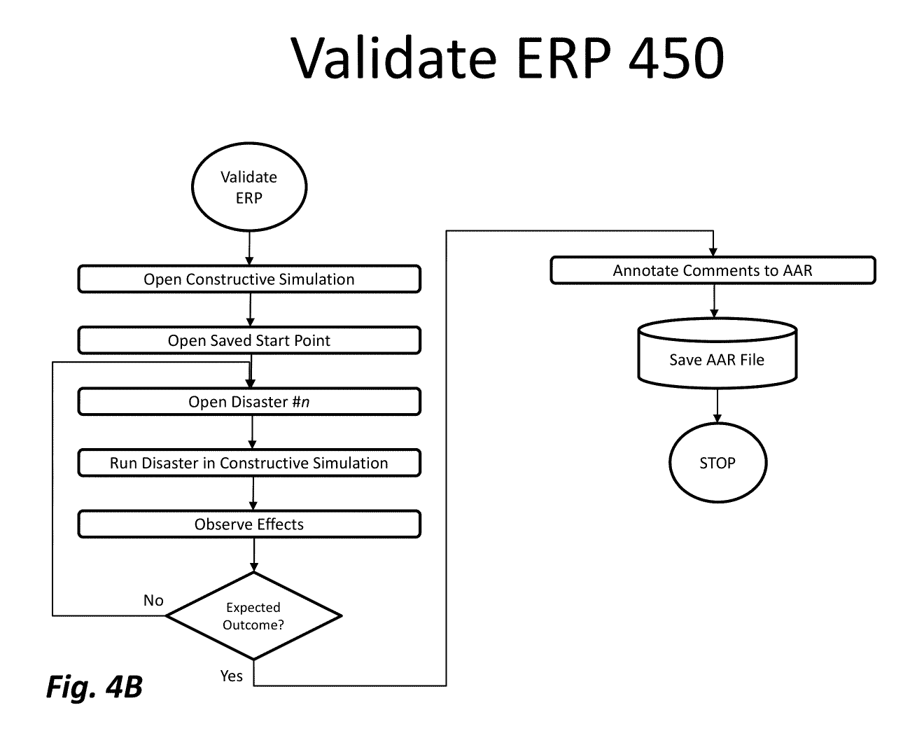

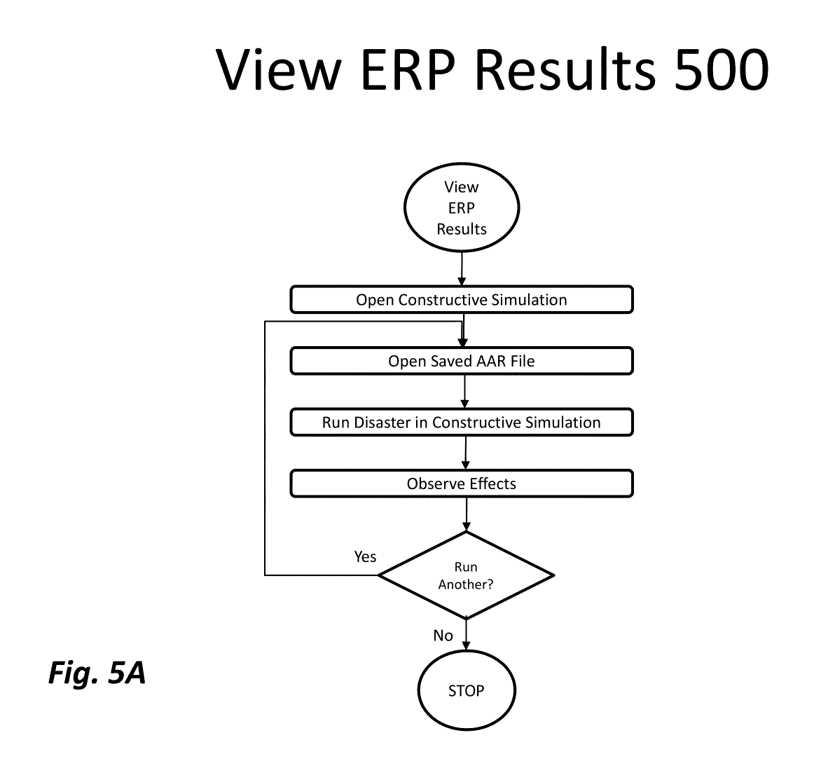

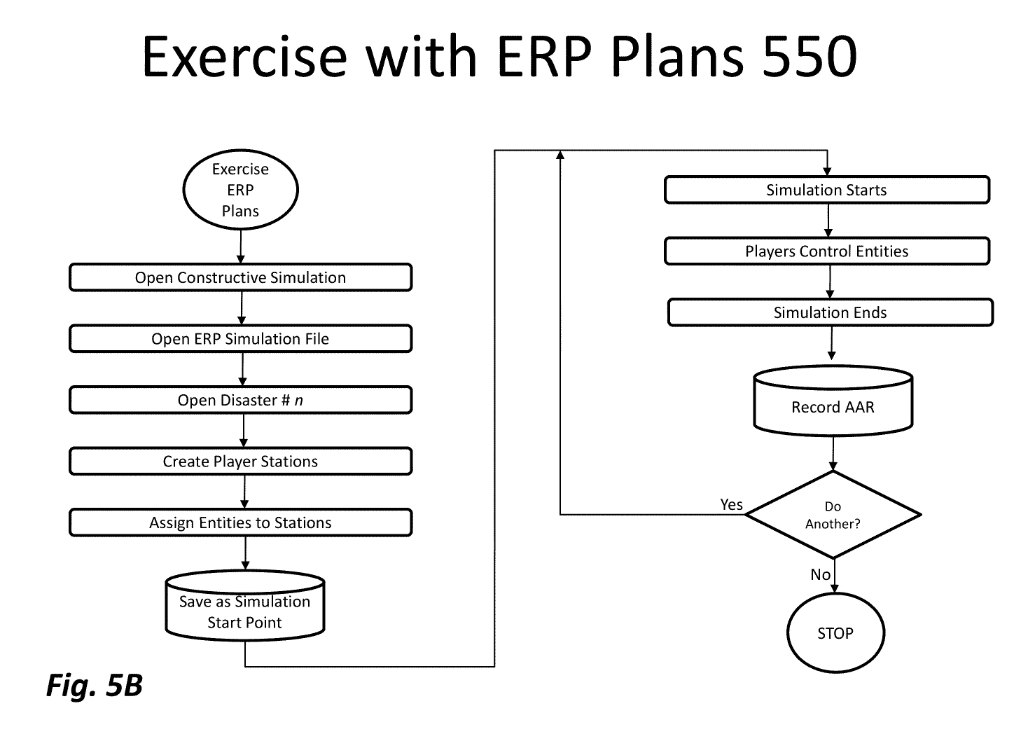

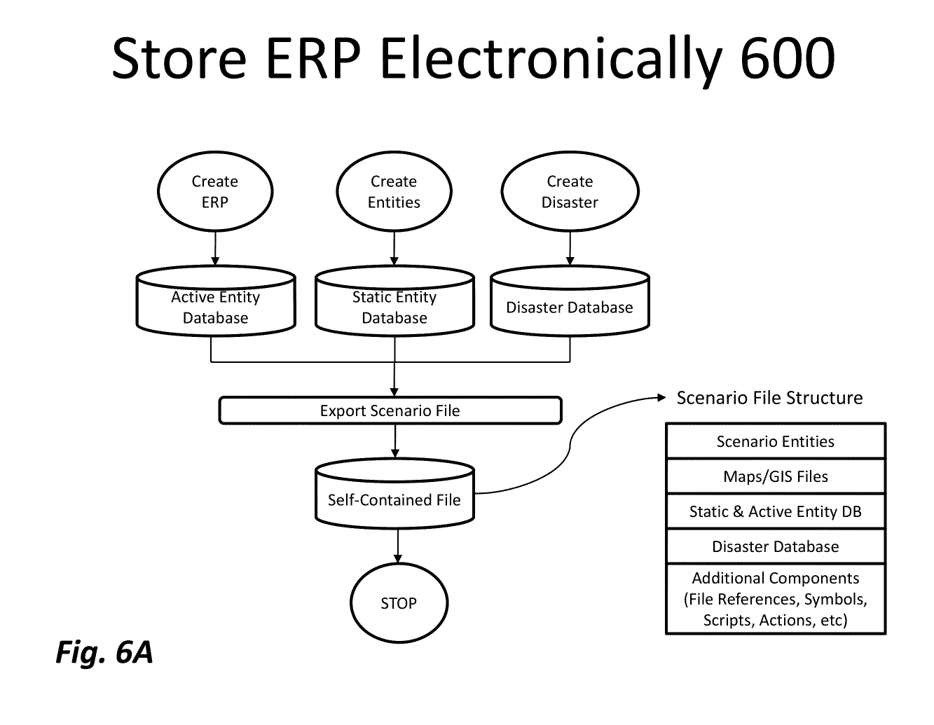

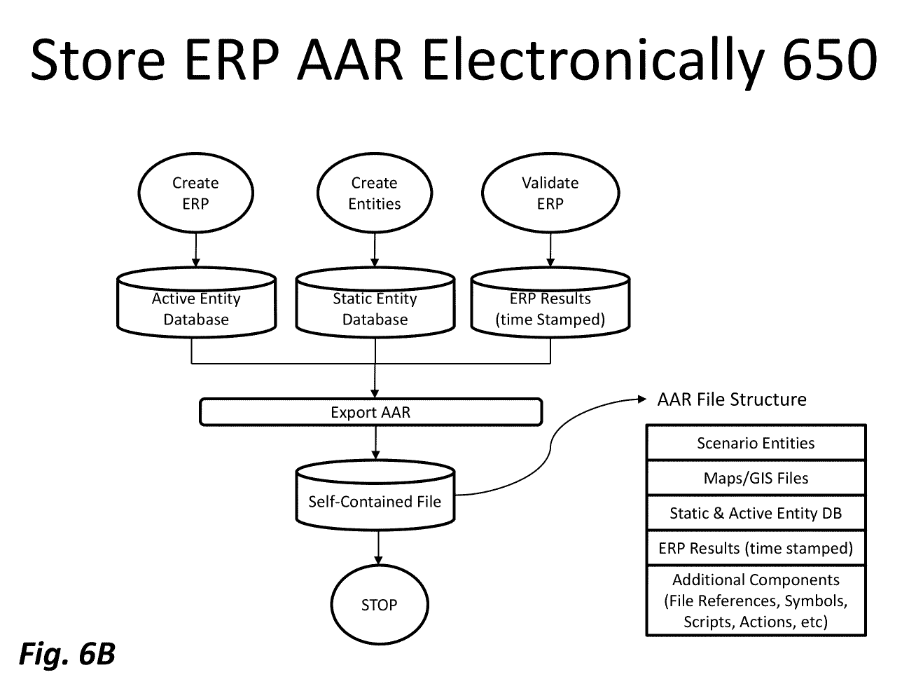

As shown in FIGS. 1, 2 and 3, a system capable of implementing the method of the invention comprises at least a master computer implementing Constructive Simulation Control Station Software, a communications interface inducing a network interface and can include an SMTP server, and a data collection and storage device for collecting data for one or more ERP characteristics. ERP characteristics can include units, entities, attributes of entities, and disaster incidents, action and reactions. Such characteristics can be stored in an ERP Simulation File (*.edm).

The master computer and at least one data collection device are adapted for connection to the network so that GIS data, not otherwise stored in the ERP simulation file, can be obtained. GIS data can be obtained from online mapping services. The master computer comprises a server computer system, adapted for connection to the network and which collects data locally or from the network from a user for the one or more characteristics. An application program is implemented on the master computer for ERP simulation creation, editing and simulation operations. Operations include assigning participants or players, local or networked, for interacting with the scenario.

Networks players can be linked via Voice-over IP Protocol (VOIP) for simulated radio/telephone systems to pass voice communications between players. Further, the application program enables a Master Scenario Events List (MSEL) tool that provides information-based messages to players in response to events that occur within the simulation.

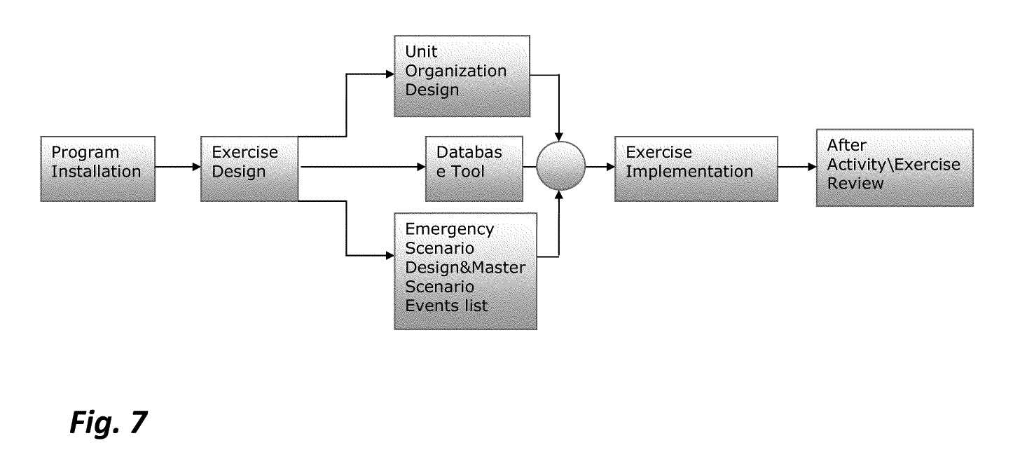

Having reference to FIG. 7, an ERP workflow program comprises program installation, exercise design, emergency implementation and After Activity Reviews (AAR).

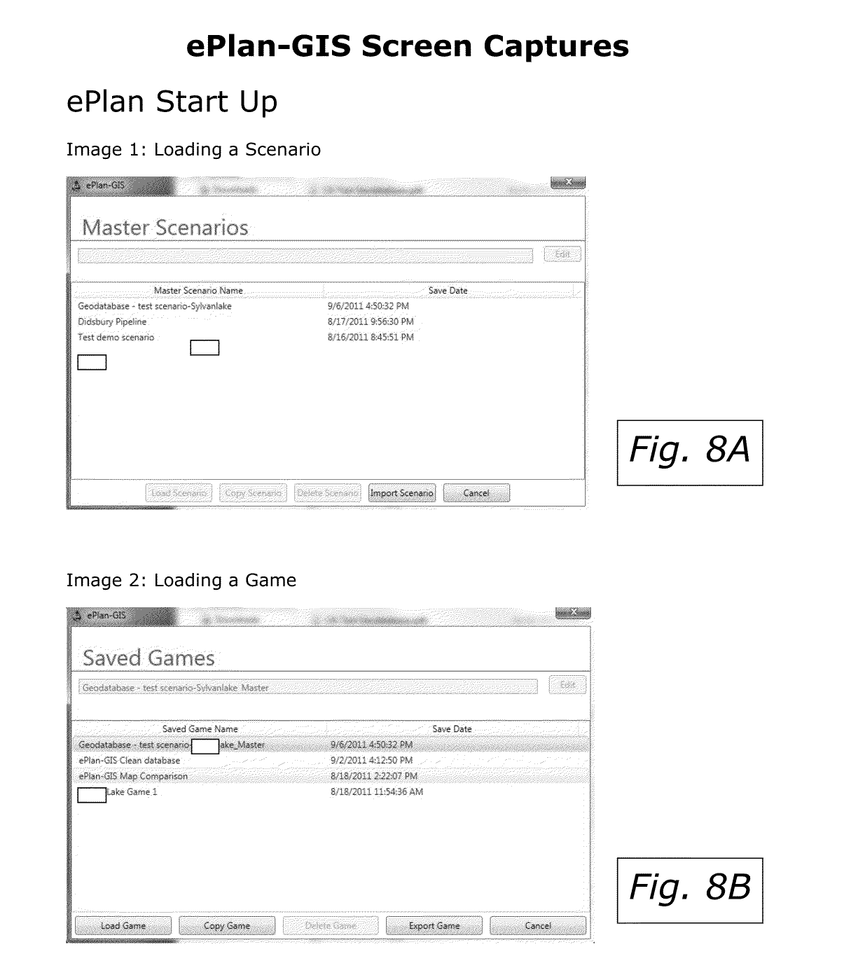

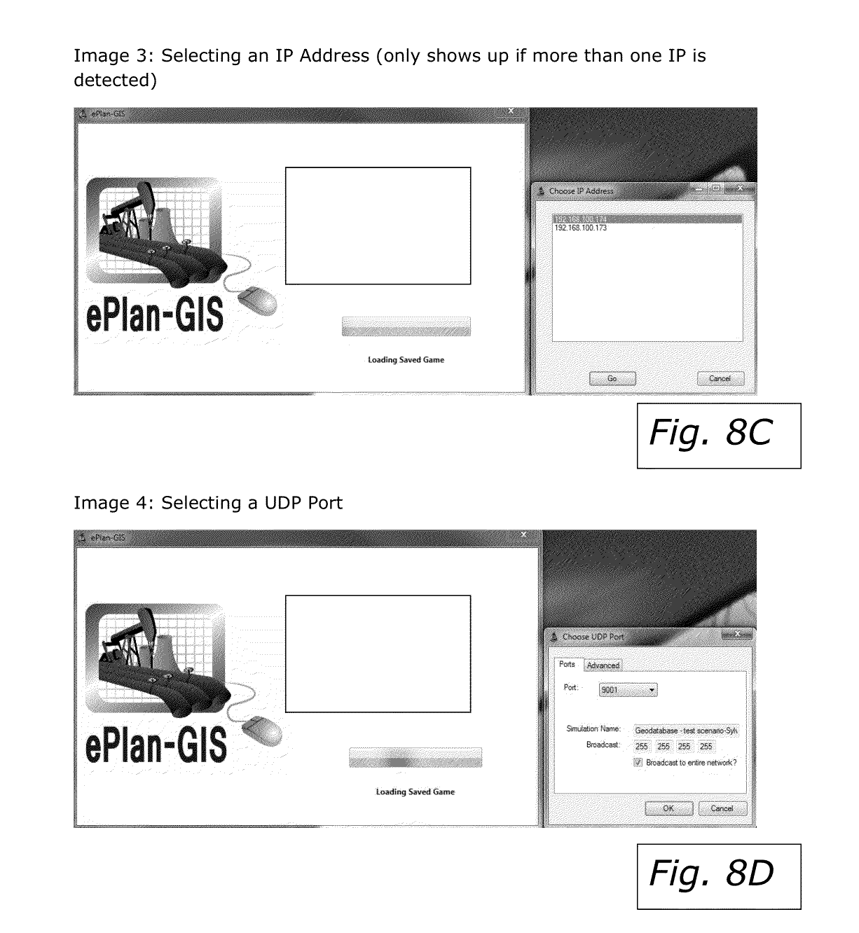

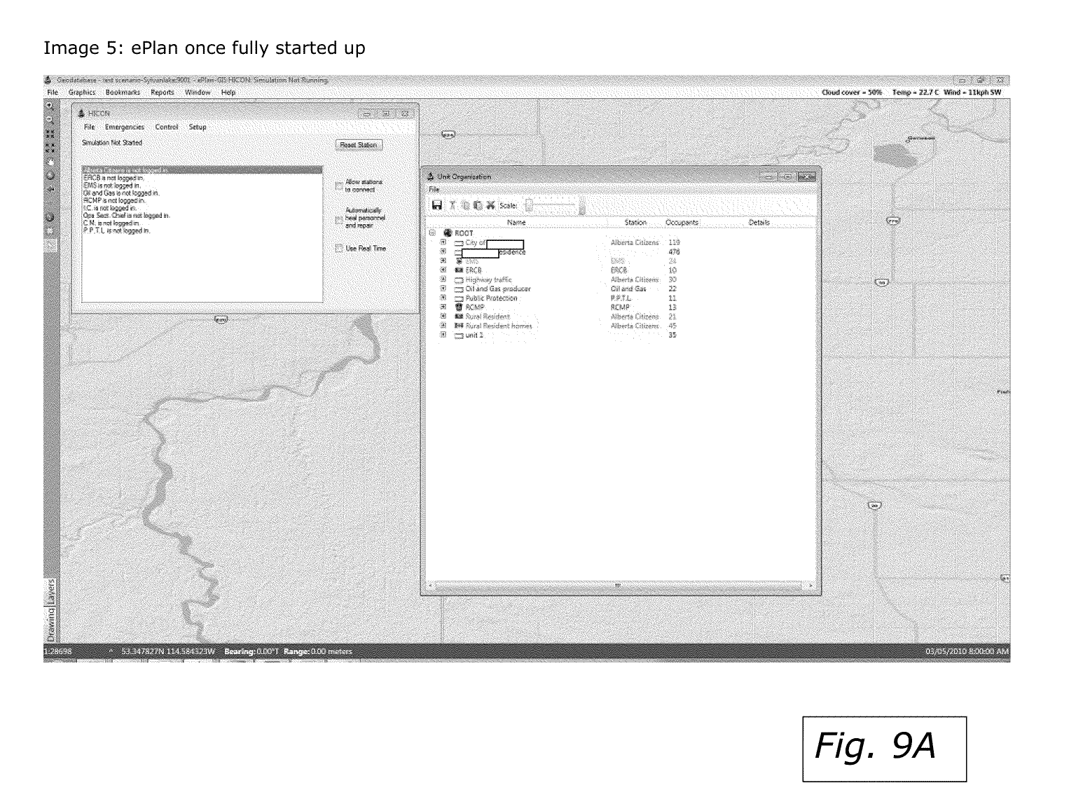

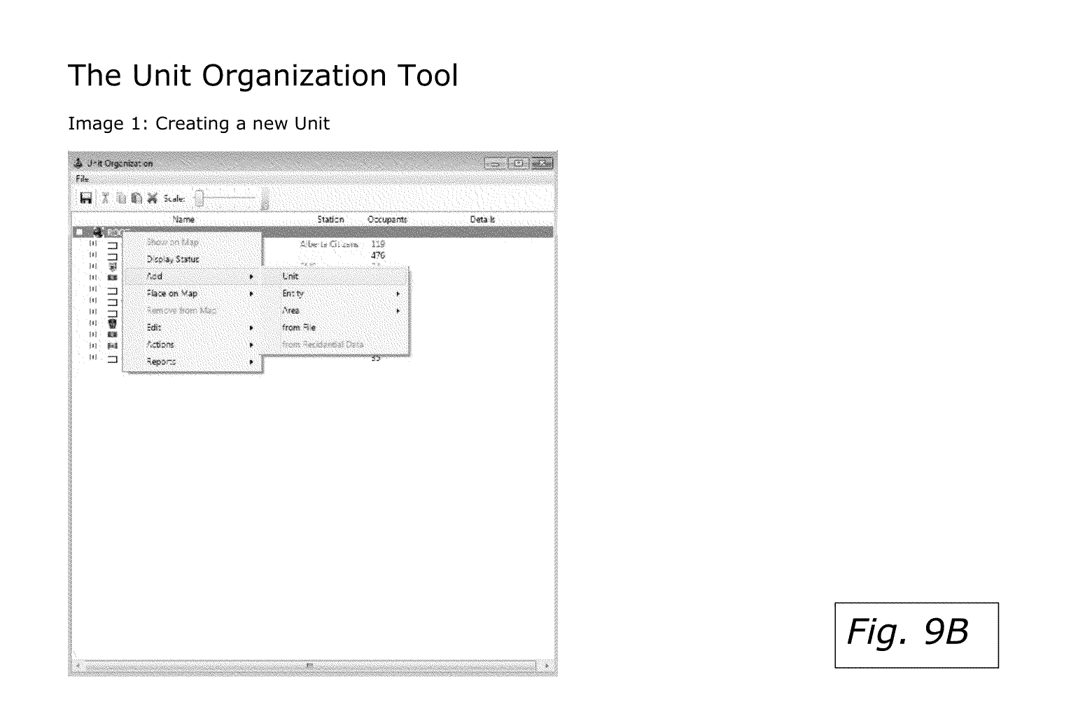

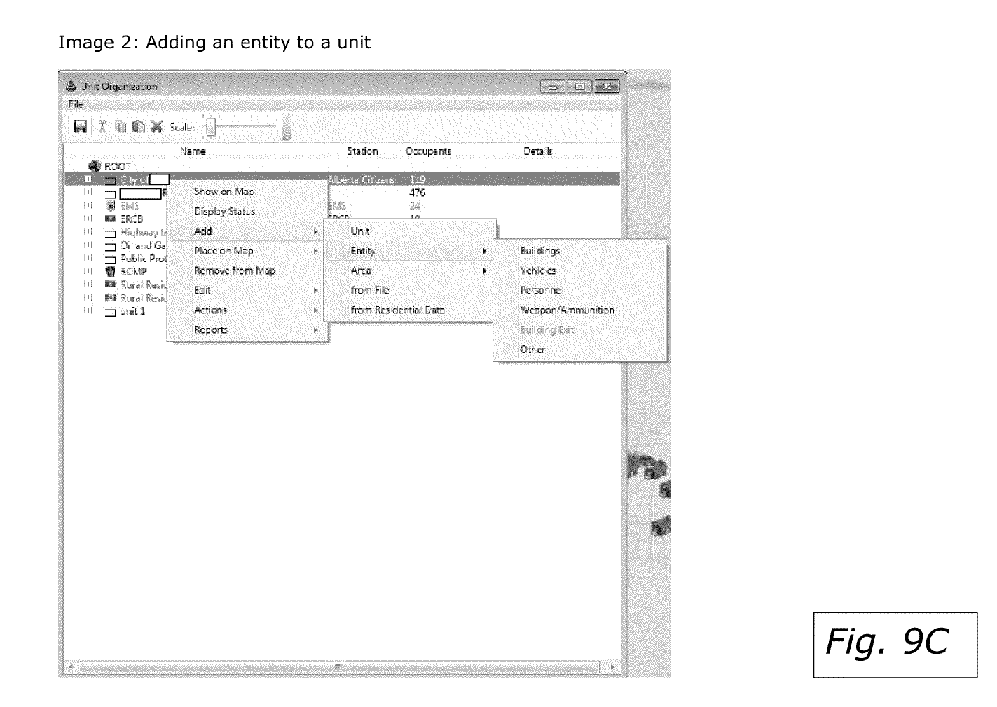

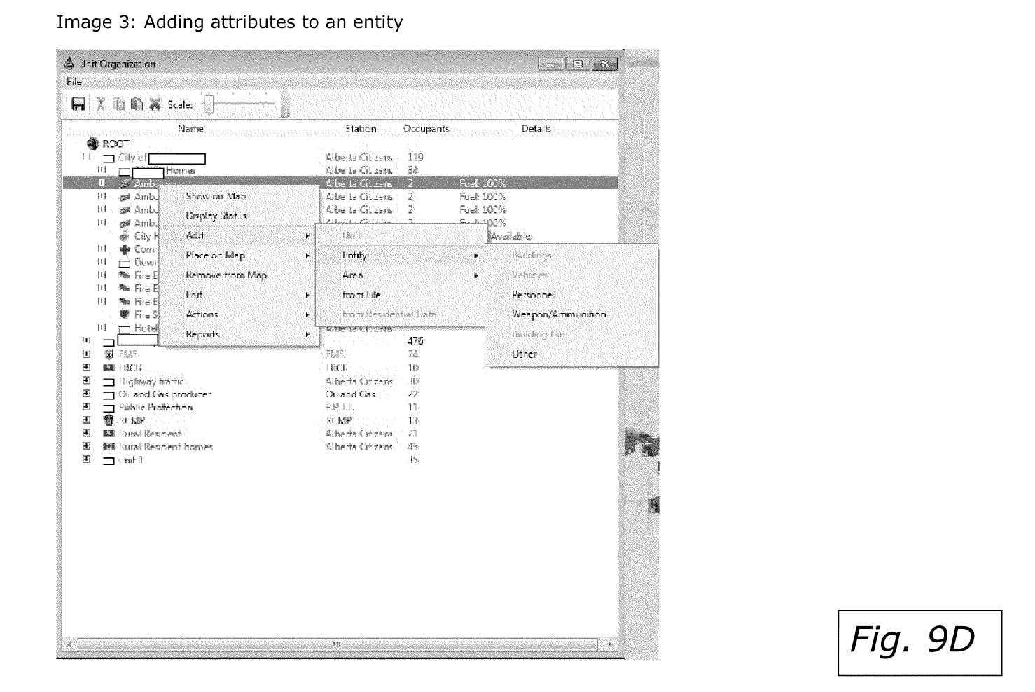

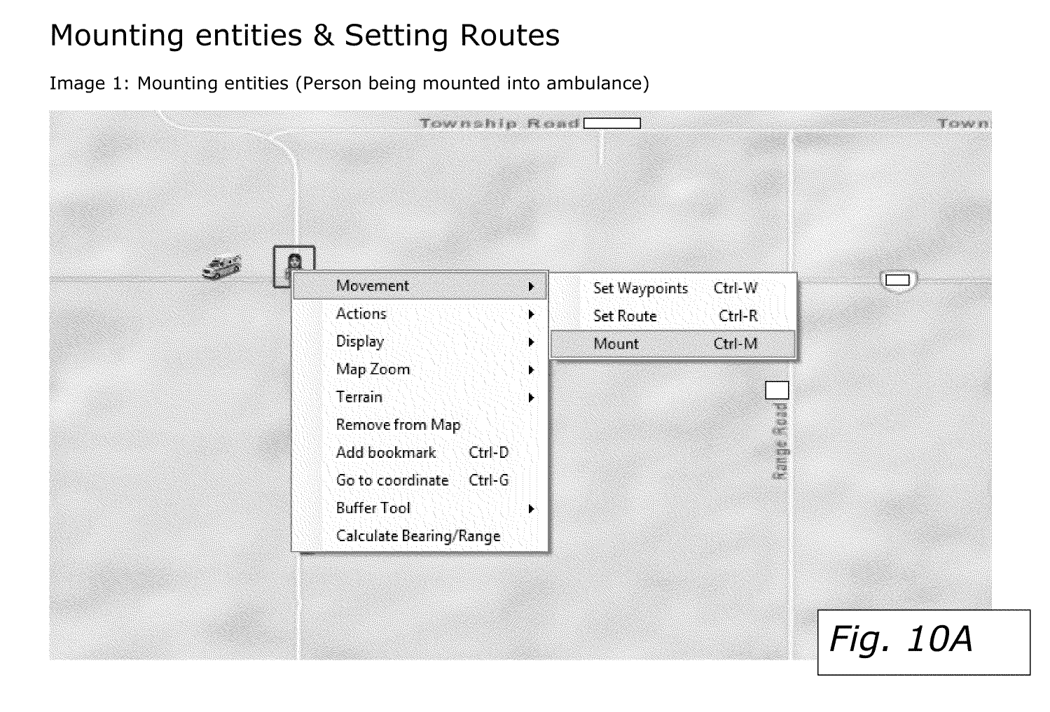

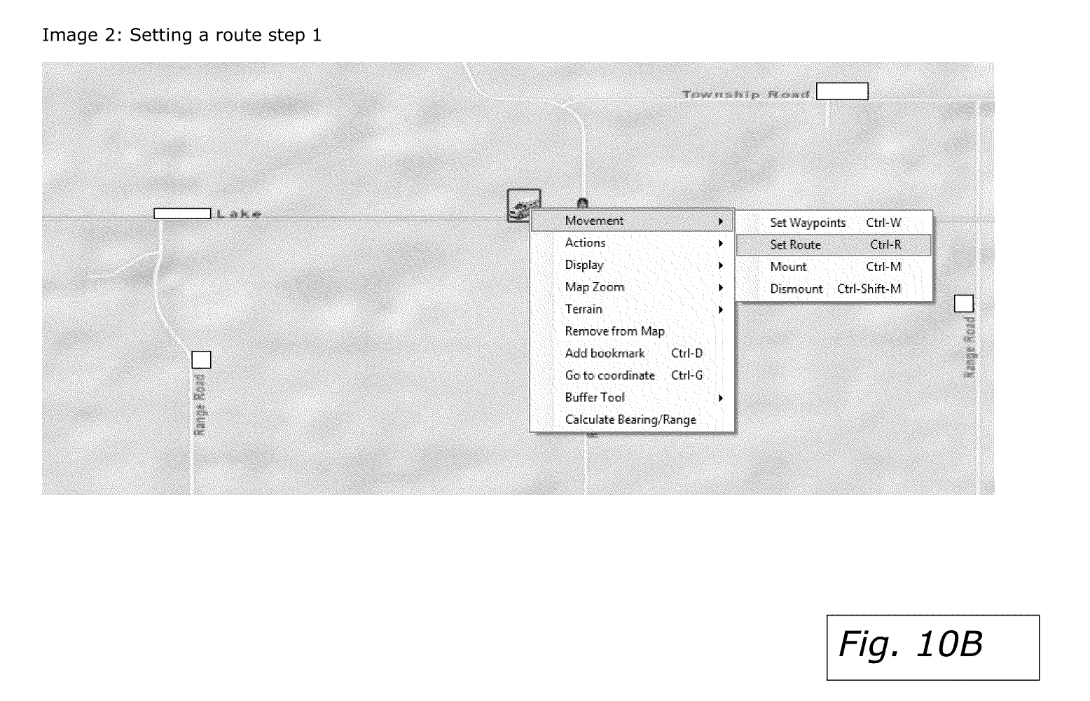

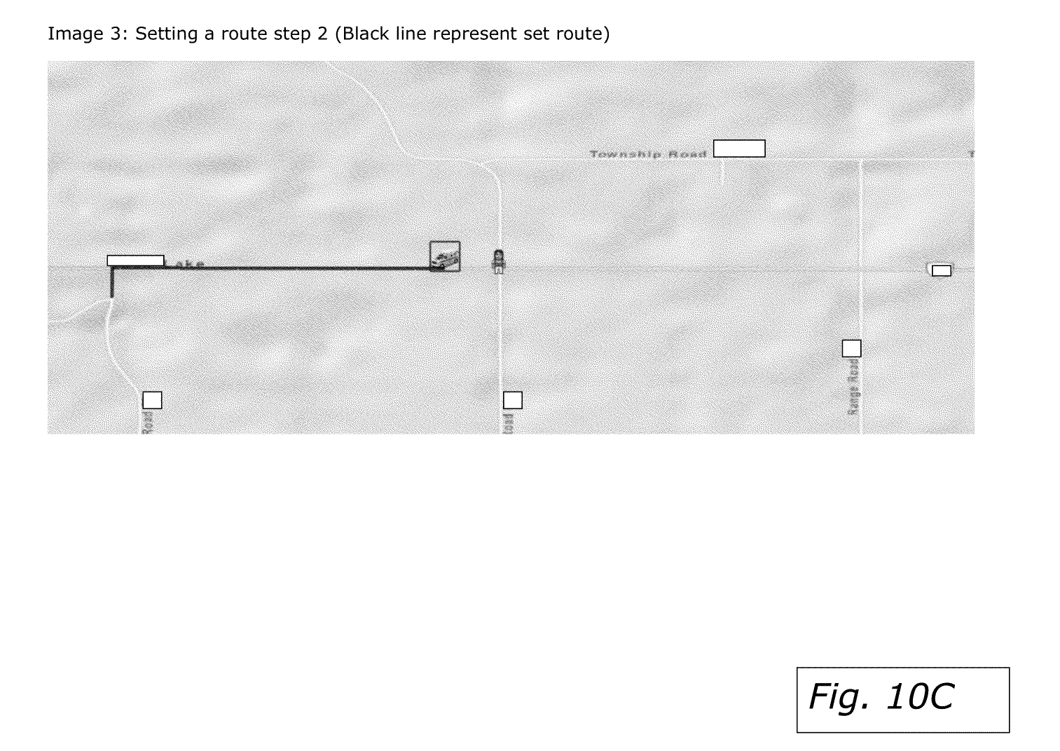

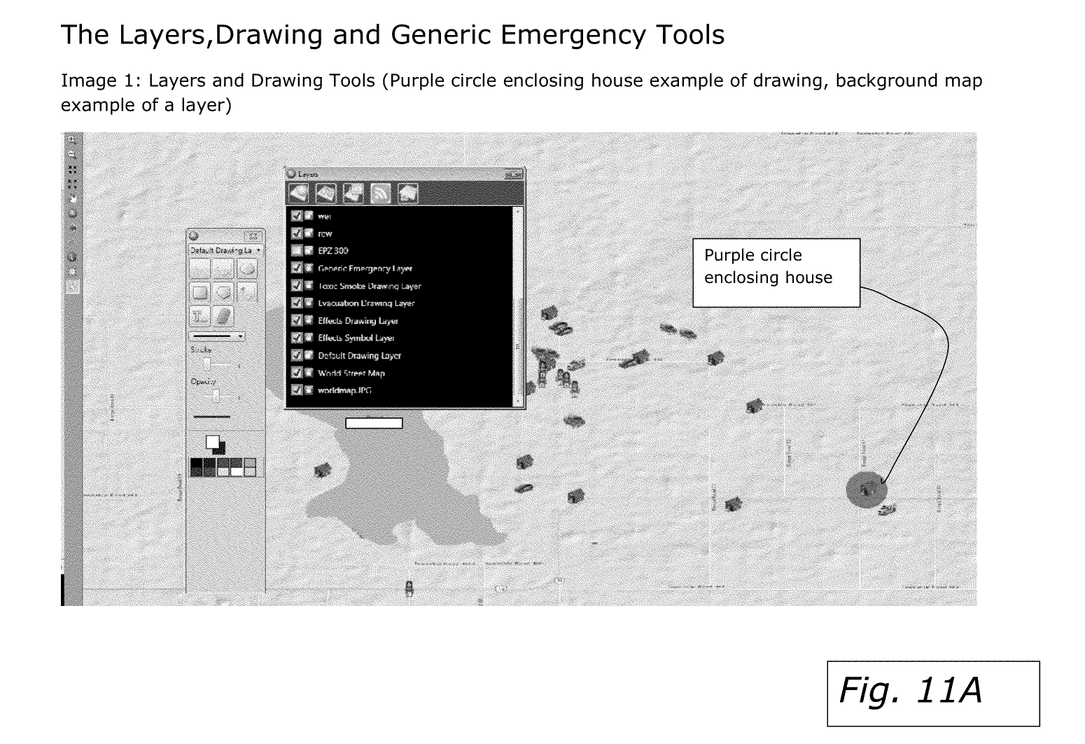

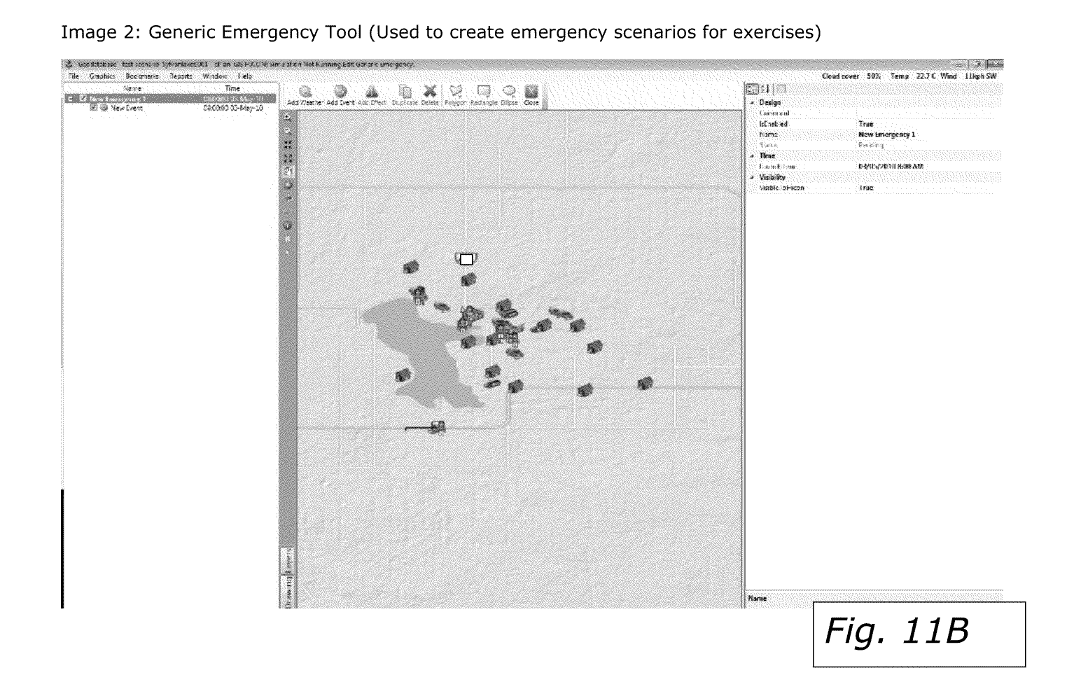

In an embodiment, as shown in FIGS. 8A to 11B, one installs and sets up an ERP, also referred to as an ePlan-GIS. Further, one designs an exercise comprising a unit organization design, adding attributes and entities using a database tool and adding incidents and messages to a generic emergency design and master scenario events list.

Using an ERP and Unit Organization tool, one designs all of the units that will be needed to run the exercise, such as Law Enforcement units, Citizens unit, Emergency Response Team unit, and Equipment Operating units, such as an Oil Producer unit.

Once all necessary units have been created, a database tool enables adding of attributes to entities held in each unit. Examples of entities are buildings, vehicles, and personnel. Further, one can create new entity types and add new attributes to entities held within units. The database tool is used to create new entity types, apply and edit entity properties, create new equipment, apply or modify equipment to entities, create new chemical or biological content, and apply or modify chemical or biological content.

Using a Generic Emergency tool one creates the type of incident(s) that the ERP exercise will simulate. One uses the Master Scenario Events list to create messages and report types that will be used during an active exercise. Once the exercise design is completed one runs the exercise or Emergency Implementation. Various implementations are set forth in FIGS. 1 to 3, in which local, multi-local and networks computers are used to design and run ERP scenarios. Exercise data is recorded.

Once the exercise has ended reports are generated, including After Activity Reviews for post-exercise assessment of the success of the exercise, what went well and what could be improved for future exercises.

A graphical interface permits display of units, entities and attributes of the simulation characteristics in an interactive map. The map displays the location of various characteristics of the simulation. Spatial data, algorithms and elements attributes are stored in a database and can be placed in the file structure. Theming data, such as color coding, symbology and animation, such as blinking, may be incorporated to provide rapid identification of elements and their state. Numerous functions are provided to permit scaling of the map to view selected geographical areas and elements of interest therein and for dynamically interacting with scenarios and the like. Elements are displayed in layers and the hierarchy for layering may be user defined, so as to display elements of interest above elements that are merely geographical or the like.

As shown in FIGS. 8A to 11B, an embodiment of an e-ERP system may incorporate a graphical interface, which uses techniques, such as scalable vector graphics (SVG) to display an entity's attributes in specific geographical locations as a dynamic, themed map. The graphical interface may be displayed in a web browser format or proprietary interface. SVG is used to render the map and map objects which include an overview map, legend and toolbar. Typically, the map is dynamic including zooming, panning, turning on and off layers and handling scaling of the map entities.

During creation and during simulation, units, entities and attributes can be visually displayed on the map. Preferably, icons or symbols represent entities, such as ambulance icons and people icons. Other theming data includes symbology and animation, such as flashing. The maps 301 are interactive. Elements 306 are clickable on the map 301, allowing the user to access information about the element and dynamic access to the element database including information regarding the element and for management.

Overlapping of displayed information, evacuation routes and scenarios can be managed through layering. Layering is automatically handled by an algorithm which displays pertinent layers atop less pertinent layers which are atop non-pertinent layers. The pertinence of a layer is determined by the elements contained within the layer. For example, a pertinent layer containing route and resources are displayed over a less pertinent layer containing elements or objects such as a body of water or a town

FIGS. 8A-11B illustrate various screen captures for defining units, entities, attributes and designing scenarios. The map and GIS systems are illustrated.

We claim:

1. A method for managing emergency response simulations comprising:
defining one or more ERP units;
defining one or more entities and attribute for such entities;
simulating a scenario by a user interactively assigning one or more units to affect the position, status and movement of one or more entities;
recording the status of the entities
retrieving and displaying relevant mapping and GIS data
displaying the status of the entities on a mapping/GIS interface;
storing the after action review data for the scenario including all static and active entity databases, all mapping and GIS data.

2. The method of claim 1 wherein
the units and entities are defined on a master computer and
the user interactively affects the position, status and movement of one or more entities on the same master computer.

3. The method of claim 1 wherein
the units and entities are defined on a master computer and
the user interactively affects the position, status and movement of one or more entities on one or more client computers networked locally with the master computer.

4. The method of claim 1 wherein
the units and entities are defined on a master computer and
the user interactively affects the position, status and movement of one or more entities on one or more client computers networked through the internet.

5. A system for managing emergency response simulations comprising:
a network;
at least one file system for storing ERP entities and their attributes, mapping and GIS information and adapted for connection to the network for supplementing mapping/GIP data from the network;
a least a master computer system, adapted for connection to the network and for receiving said data from the data collection device and for storing said data in a first ERP database;
a mapping/GIS interface displaying at least spatial data of the at least one entity on at least the master computer
